(19) United States
(12) Patent Application Publication
(10) Pub. No.: US 2026/0260186 A1
(43) Pub. Date: Sep. 3, 2026

(54) METHODS OF PERFORMING AND RECORDING COMPLETION OF AN OPERATION

(71) Applicant: The Boeing Company, Arlington, VA (US)

(72) Inventors: Jason John Cochrane, Tecoma (AU); Beau Tristan Colley-Allerton, Fitzroy North (AU)

(21) Appl. No.: 19/068,306

(22) Filed: Mar. 3, 2025

(51) Int. Cl. G06Q 10/0631; G06F 21/31; G06F 21/44; G06Q 50/04; H04W 4/029

(52) U.S. Cl. CPC G06Q 10/063114; G06F 21/31; G06F 21/44; G06Q 50/04; H04W 4/029

(57) ABSTRACT

Methods of performing and recording completion of an operation are presented. A location of a tool is determined within a work environment. The operation on a part in the work environment is performed using the tool. The tool records performed parameters of the operation including the location of the tool during performance of the operation. A digital record of the operation is generated using the performed parameters of the operation.

### BACKGROUND INFORMATION

### 1. Field

The present disclosure relates generally to performing manufacturing operations and more specifically to recording completion of manufacturing operations.

### 2. Background

In manufacturing, work completed by an operator is manually signed off. Pen and paper can be used to manually enter relevant values for the operation in a table. However, in some cases, it is not possible to verify accuracy of recorded values. Additionally, some types of data cannot be recorded on a simple checklist.

Therefore, it would be desirable to have a method and apparatus that takes into account at least some of the issues discussed above, as well as other possible issues. For example, it would be desirable to provide a method of recording completion of manufacturing operations.

### SUMMARY

An embodiment of the present disclosure provides a method of performing and recording completion of an operation. A location of a tool within a work environment is determined. The operation is performed on a part in the work environment using the tool. Performed parameters of the operation including the location of the tool during performance of the operation are recorded by the tool. A digital record of the operation is generated using the performed parameters of the operation.

Another embodiment of the present disclosure provides a method of performing and recording completion of an operation. A location of a tool is determined within a work environment. Instructed parameters for an operation to be performed on a part by the tool are received by the tool. The operation is performed on the part in the work environment using the tool based on the instructed parameters. Performed parameters of the operation including the location of the tool during performance of the operation are recorded by the tool. A digital record of the operation is generated using the performed parameters of the operation.

Yet another embodiment of the present disclosure provides a method of performing and recording completion of an operation. A location of a tool within a work environment is determined using sensors connected to the tool. The operation is performed on a part in the work environment according to a model based engineering definition using the tool. Performed parameters of the operation including the location of the tool during performance of the operation are recorded by the tool. A digital record of the operation is generated using the performed parameters of the operation.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is a flowchart of a method of performing and recording completion of an operation in accordance with an illustrative embodiment;

FIG. 4 is an illustration of functions of tool configured to perform and record completion of an operation in accordance with an illustrative embodiment;

FIG. 5 is an illustration of an isometric view of a tool in accordance with an illustrative embodiment;

FIGS. 6A and 6B are a flowchart of a method of performing and recording completion of an operation in accordance with an illustrative embodiment;

FIGS. 7A and 7B are a flowchart of a method of performing and recording completion of an operation in accordance with an illustrative embodiment;

FIG. 8 is a flowchart of a method of performing and recording completion of an operation in accordance with an illustrative embodiment;

FIG. 9 is an illustration of an aircraft manufacturing and service method in a form of a block diagram in accordance with an illustrative embodiment; and

FIG. 10 is an illustration of an aircraft in a form of a block diagram in which an illustrative embodiment may be implemented.

### DETAILED DESCRIPTION

The illustrative examples recognize and take into account several considerations. The illustrative examples recognize and take into account that due to the complex set of operations in aerospace manufacturing, full automation of the entire assembly or manufacturing process is conventionally not performed. The illustrative examples recognize and take into account that in aerospace manufacturing, there is a hybrid of manual operations interspersed with automation.

The illustrative examples recognize and take into account that currently the majority of work completed by an operator is manually signed off with no physical evidence or data collected that can be used to verify the work has been completed correctly.

The illustrative examples recognize and take into account that photos can provide some visual evidence of the finished product but give no insight into how the process was carried out. The illustrative examples recognize and take into account that even when using tools with the technology to generate relevant data such as a torque wrench that measures fastener torque or a drill that monitors RPM, there is no practical way to automatically record these values and match them to their respective physical operation locations.

The illustrative examples recognize and take into account that pen and paper can be used to manually mark off operational values in a table, but in some cases it may not be possible to verify that they have been performed or recorded correctly, or that the correct tool was used. The illustrative examples recognize and take into account that other types of data, such as the order operations are completed in, and if each operation was completed, often cannot be verified when marked as complete on a simple checklist.

The illustrative examples recognize and take into account that existing conventional work flows can begin with an operator looking at work instructions for a task to do and where it must be done. The illustrative examples recognize and take into account that in this step, an order of operations can be a source of error.

In conventional operations, the operator then translates two dimensional instructions into an actual work piece operation location. The illustrative examples recognize and take into account that in this step, an incorrect work location can be a source of error.

In conventional operations, the operator then performs the operation at the work instruction indicated location with a manual tool. The illustrative examples recognize and take into account that in this step, often there is no digital trace of tool metrics such as fastener torques, drill rpm/feed pressures, countersunk depth, or a quantity of sealant applied.

The illustrative examples recognize and take into account that conventionally, after performing operations, post inspection can be performed manually. The illustrative examples recognize and take into account that measurements for quality are gathered using dedicated tools such as go/no-go blocks, countersink measurement gauges, hole probes, and cameras. The illustrative examples recognize and take into account that records for quality are manually entered or correlated to their physical operation location and step. The illustrative examples recognize and take into account that in this step, a source of error can be in record keeping.

The illustrative examples provide a digitized record of work completed. The illustrative examples provide potential of eliminating paper and manual recording ensuring work completion. The illustrative examples provide a localization component that is not limited to enclosed spaces. The illustrative examples provide a system that combines the MBE definition with the localization and tool data capture.

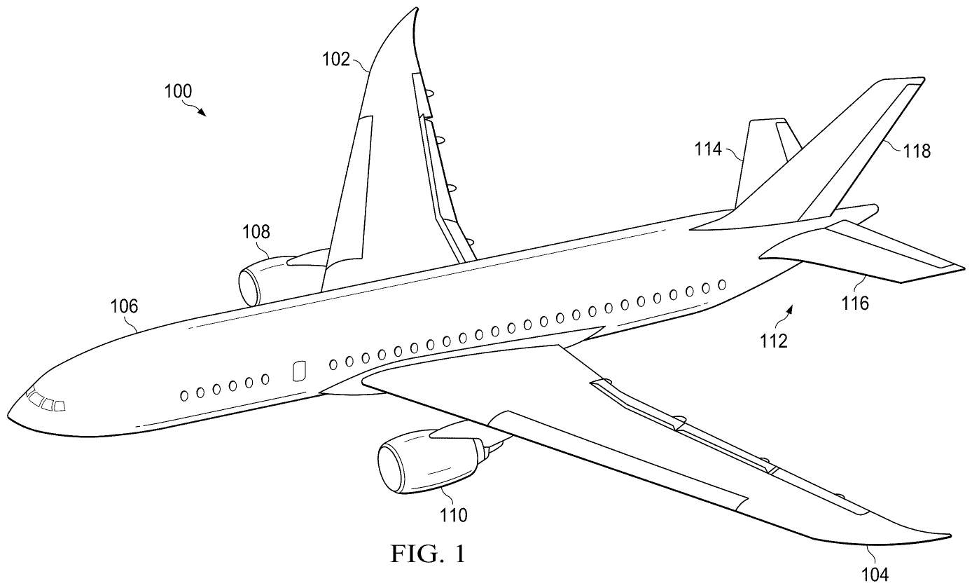

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have components manufactured using the methods of the illustrative examples. At least one of wing 102, wing 104, or body 106 can be manufactured using the methods of performing and recording completion of an operation.

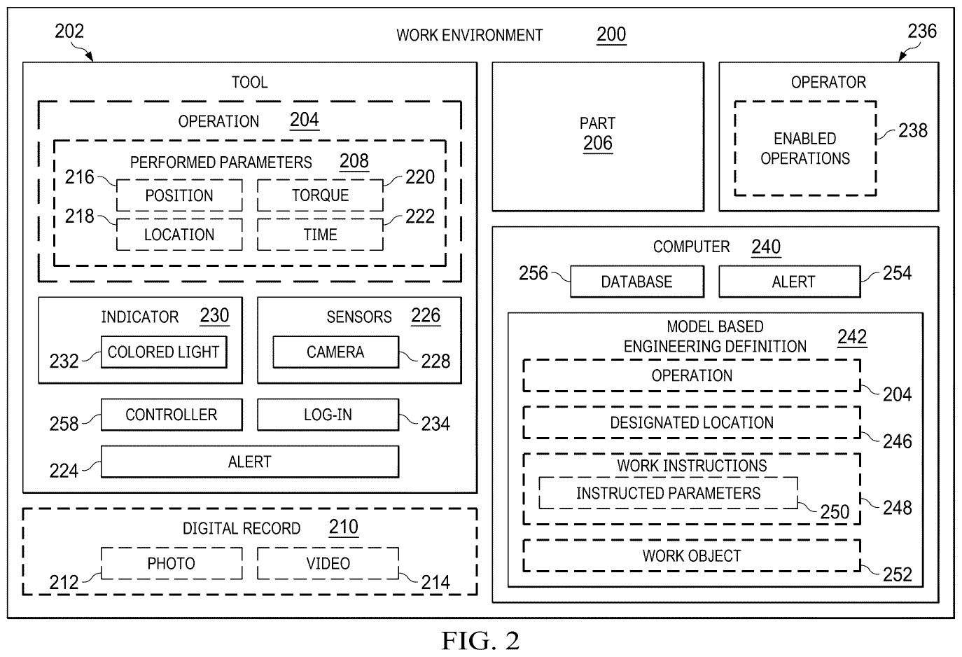

Turning now to FIG. 2, an illustration of a block diagram of a manufacturing environment is depicted in accordance with an illustrative embodiment.

Work environment 200 is an environment in which operator 236 performs operation 204 on part 206 using tool 202. The illustrative examples provide methods of performing and recording completion of operation 204. Prior to performing operation 204, location 218 of tool 202 within work environment 200 is determined.

Location 218 of tool 202 can be determined using any desirable method. In some illustrative examples, a local positioning system is used to localize tool 202 within a work cell. Local positioning systems can use multiple cameras positioned around the work area to triangulate the position of a tracked object. However, to use a local positioning system, the object is visible to more than one camera at all times. To cover a large workpiece would utilize a possibly undesirably large quantity of cameras. Depending on the geometry of part 206, there may be occlusions for a local positioning system. In some illustrative examples, localizing tool 202 is performed using at least one of indoor GPS, SLAM based methods, external camera-based methods, fiducial tags, RGB/RGBD feature recognition from onboard cameras, or any other desirable localization system. In some illustrative examples, camera 228 is used to locate tool 202 in work environment 200. In some illustrative examples, location 218 of tool 202 is determined using sensors 226 connected to tool 202.

Operation 204 is performed on part 206 in work environment 200 using tool 202. Operation 204 can include any desirable operation during assembly of part 206. In some illustrative examples, operation 204 can be drilling a hole, tightening a bolt, tightening a screw, securing a rivet, or any other desirable operation.

Tool 202 records performed parameters 208 of operation 204 including location 218 of tool 202 during performance of operation 204. Performed parameters 208 include any desirable aspects of operation 204 or tool 202 during operation 204. Performed parameters 208 can include speed, force, or any other desirable aspect of operation 204. In some illustrative examples, performed parameters 208 comprise position 216 of tool 202 within work environment. Position 216 can comprise a representation of a direction of an operative component of tool 202. Position 216 of tool 202 can be expressed in three axes. For example, position 216 of tool 202 for a drill can comprise an angle of the drill bit of tool 202 within work environment 200. Performed parameters 208 comprise time 222 of performance of operation 204.

Digital record 210 of operation 204 is generated using performed parameters 208 of operation 204. Digital record 210 can be used to verify completion of operation 204 according to work instructions 248. Digital record 210 can be used to qualify part 206. In some illustrative examples, digital record 210 comprises at least one of photo 212 or video 214. Photo 212 can be a photo of part 206 after operation 204. Video 214 can be a video during operation 204 on part 206. Digital record 210 can be saved in database 256 of computer 240.

Prior to performing operation 204, model based engineering definition 242 is received for operation 204. Operation 204 is performed based on model based engineering definition 242 for operation 204. Model based engineering definition 242 includes work instructions 248 for operation 204 at designated location 246 of work object 252. Work instructions 248 include instructed parameters 250 for operation 204. Tool 202 can utilize instructed parameters 250 of work instructions 248 to perform operation 204. In some illustrative examples, instructed parameters 250 are extracted from model based engineering definition 242 by tool 202. In some illustrative examples, instructed parameters 250 comprise at least one of a type of operation 204, designated location 246 for tool 202 while performing operation 204, torque 220 for operation 204, and part 206 to receive operation 204.

In some illustrative examples, performed parameters 208 are compared to model based engineering definition 242 to verify operation 204 was performed according to model based engineering definition 242. In some illustrative examples, alert 224 can be generated if operation 204 was not performed according to model based engineering definition 242. In some illustrative examples, alert 254 is generated in computer 240 in response to a determination that operation 204 was not performed according to model based engineering definition 242. In some illustrative examples, alert 254 is generated if location 218 is different from designated location 246. In some illustrative examples, alert 254 is generated if a force, torque 220, speed, or other parameter of performed parameters 208 is different from instructed parameters 250.

Tool 202 receives model based engineering definition 242 and performs operation 204 according to model based engineering definition 242. Prior to performing operation 204, tool 202 can verify whether operator 236 is authorized to perform operation 204. In some illustrative examples, tool 202 receives log-in 234 from operator 236. Log-in 234 can comprise any desirable data indicating an identity of operator 236. Log-in 234 can comprise at least one of a fingerprint, an iris, a facial scan, a PIN, a password, a RFID device, a QR code, a bar code, another desirable form of biometric log-in, or any other desirable form of log-in. In some illustrative examples, tool 202 logs log-in 234 to save the identity of operator 236 as a performed parameter or performed parameters 208. In some illustrative examples, identity of operator 236 is not saved. In some illustrative examples, identity of operator 236 is saved as an entry separately from performed parameters 208. In some illustrative examples, operator 236 has enabled operations 238. If operation 204 is one of enabled operations 238, operator 236 is authorized to perform operation 204. In some illustrative examples, it is determined if operation 204 is an enabled operation associated with log-in 234. In these illustrative examples, enabled operations 238 for operator 236 would be enabled operations associated with log-in 234.

In some illustrative examples, tool 202 is unlocked in response to determining operation 204 is an enabled operation of enabled operations 238. In some illustrative examples, tool 202 is locked if operation 204 is not an enabled operation of enabled operations 238 for operator 236. In some illustrative examples, operation 204 can use specialized training or expertise. Verifying whether operator 236 is allowed to perform operation 204 can prevent operation 204 from being performed by untrained individuals.

In some illustrative examples, location 218 of tool 202 is compared to designated location 246 for performing the operation 204. In some illustrative examples, tool 202 is locked in response to determining tool 202 is not in designated location 246. In some illustrative examples, indicator 230 is presented on tool 202 to indicate a result of the determining if location 218 of tool 202 is designated location 246. In some illustrative examples, presenting indicator 230 includes illuminating a colored light 232 on tool 202. In some illustrative examples, indicator 230 is presented on a digital device controlled by operator 236.

In some illustrative examples, prior to performing operation 204, location 218 of a tool 202 within work environment 200 is determined. Tool 202 receives instructed parameters 250 for operation 204 to be performed on part 206 by tool 202. Operation 204 is performed on part 206 in work environment 200 using tool 202 based on instructed parameters 250. Tool 202 records performed parameters 208 of operation 204 including location 218 of tool 202 during performance of operation 204. Digital record 210 of operation 204 is generated using performed parameters 208 of operation 204.

In some illustrative examples, receiving instructed parameters 250 for operation 204 comprises receiving a model based engineering definition 242 for operation 204, and wherein performing operation 204 comprises performing operation 204 based on model based engineering definition 242 for operation 204. In some illustrative examples, it is verified whether operation 204 was performed according to model based engineering definition 242 by comparing performed parameters 208 to model based engineering definition 242. In some illustrative examples, tool 202 is locked if operation 204 was not performed according to model based engineering definition 242. In some illustrative examples, other operations are not performed by tool 202 until the differences between performed parameters 208 of operation 204 and model based engineering definition 242 are addressed. In some illustrative examples, a rework is done for operation 204. In some illustrative examples, operation 204 is repeated to be performed according to model based engineering definition 242.

In some illustrative examples, alert 224 is generated if operation 204 was not performed according to model based engineering definition 242. Alert 224 can take the form of an auditory or visual alert. In some illustrative examples, alert 224 can be displayed on tool 202. In some illustrative examples, alert 224 can be displayed on a digital device for operator 236. In some illustrative examples, alert 224 can be recorded in digital record 210.

The illustration of work environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

Each of the features of the illustrative examples can be implemented in multiple ways. For example, localizing the tool with respect to the work object can be according to any desirable localization method.

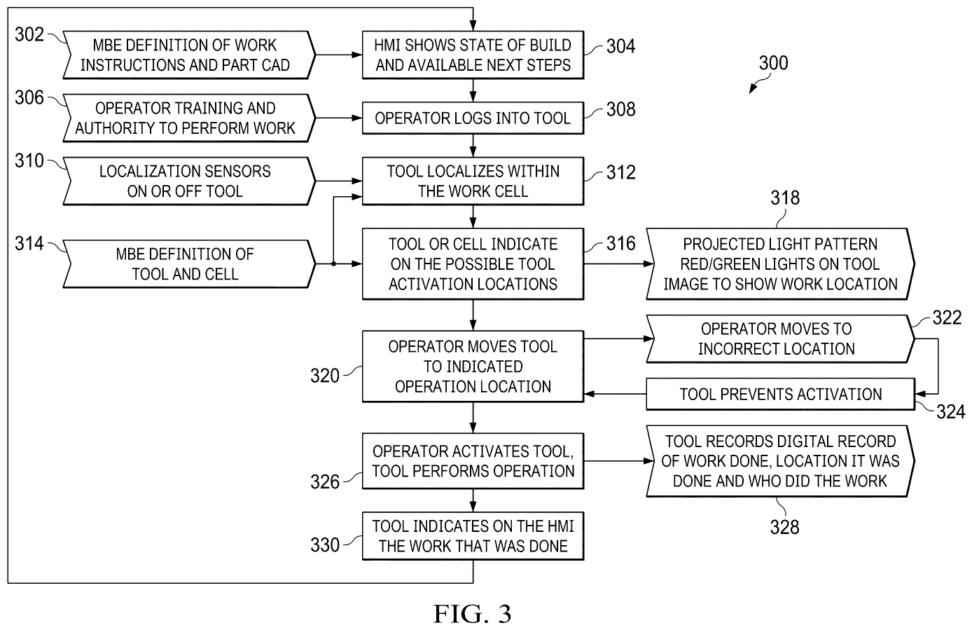

Turning now to FIG. 3, a flowchart of a method of performing and recording completion of an operation is depicted in accordance with an illustrative embodiment. Method 300 can be performed to manufacture at least one component of aircraft 100 of FIG. 1. Method 300 can be performed in work environment 200 of FIG. 2.

The MBE definition of work instructions and part CAD 302 are provided to a controller on a tool. The human machine interface (HMI) shows a state of build and available next steps 304. The HMI can be displayed on the tool itself or on any desirable digital device. In some illustrative examples, operator training and authority to perform work 306 is optionally provided to the tool. In some illustrative examples, an operator logs into tool 308. In some illustrative examples, the tool can prevent tool activation if the operator is not authorized to perform the operation.

Localization sensors on or off tool 310 provide information. In some illustrative examples, the localization sensors are part of a location positioning system comprising at least one of a global positioning system (GPS), local position system (LPS), RFID system, WiFi, intertial or optical SLAM, or any other desirable localization system. In some illustrative examples, the localization sensors are on the tool and can be used without a local positioning system with workplace boundaries.

In some illustrative examples, an MBE definition of tool and cell is provided to the tool 314. Tool localizes within the work cell 312 using at least one of the localization sensors and the MBE definition.

In some illustrative examples, tool or cell indicate on the possible tool activation locations 316. In some illustrative examples, projected light pattern red/green lights on tool image to show work location 318. In some illustrative examples, 316 and 318 can be performed by projecting or lighting lights in the work cell. In some illustrative examples, 316 and 318 can be performed by displaying possible activation locations on the tool itself or on a separate digital device.

Operator moves tool to indicated operation location 320. If an operator moves to incorrect location 322, in some illustrative examples, tool prevents activation 324. In these illustrative examples, by locking out the tool, an operation is performed in only correct locations.

Operator activates tool and tool performs operation 326. At least one of during or following the operation, tool records digital record of work done, location it was done, and who did the work 328. The digital record comprises performed parameters including at least one of the operation done, measurements during the operation, the location, or the operator who performed the operation. After performing the operation, the tool indicates on the human machine interface (HMI) the work that was done 330. The HMI can take the form of a screen, a display, buttons, lights, or any other desirable type of interface.

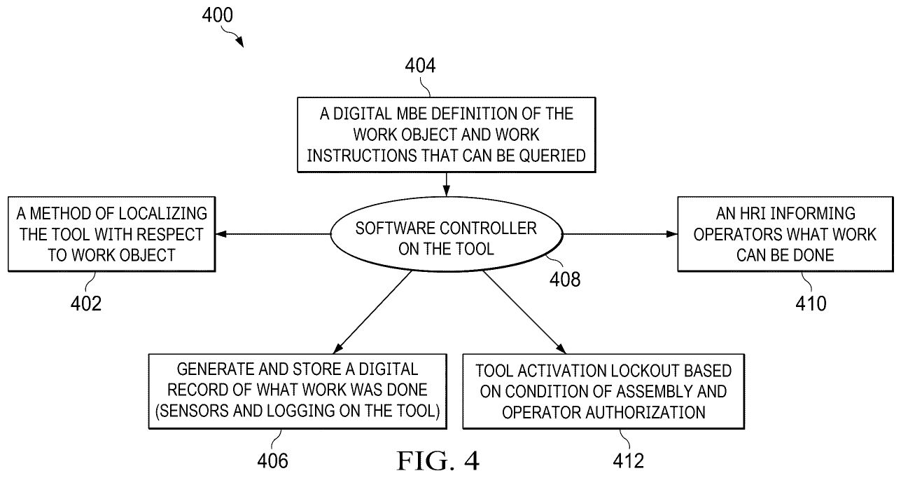

Turning now to FIG. 4, an illustration of functions of a tool configured to perform and record completion of an operation is depicted in accordance with an illustrative embodiment. Software controller on the tool 408 can be utilized in manufacturing a component of aircraft 100 of FIG. 1. Software controller on the tool 408 can be implemented on tool 202 as controller 258. Software controller on the tool 408 can be utilized to perform operations of method 300 of FIG. 3.

Diagram 400 depicts inputs and outputs to software controller on the tool 408. A method of localizing the tool with respect to work object 402 is performed by software controller on the tool 408. In some illustrative examples, software controller on the tool 408 saves results from method of localizing tool with respect to work object 402.

A digital MBE definition of the work object and work instructions that can be queried 404 is provided to software controller on the tool 408. The digital MBE definition of the work object and work instructions that can be queried 404 can be used by software controller on the tool 408 at least one of prior to, during, or after performing an operation using the tool. The digital MBE definition of the work object and work instructions that can be queried 404 can be used by software controller on the tool 408 to verify at least one of a location for the tool, components of the tool such as drill bits, wrench sizes, or other features, or enabled operators for the operation prior to performing the operation. The digital MBE definition of the work object and work instructions that can be queried 404 can be used by software controller on the tool 408 to verify performed parameters of the operation are within ranges of the work instructions from the digital MBE definition. HRI informing operators what work can be done 410 provides indicators to operators regarding performing the operation using software controller on the tool 408. In some illustrative examples the HRI comprises at least one of text, colored lights, or spoken instructions. The HRI can be provided directly on the tool or on another portable digital device such as a tablet, a phone, or a computer. In some illustrative examples, the digital MBE definition received in 404 is used by software controller on the tool 408 is used to provide the HRI in 410. In some illustrative examples, the method of localizing the tool in 402 is used to provide the HRI in 410.

Following the operation, software controller on the tool 408 is used to generate and store a digital record of what work was done (sensors and logging on the tool) 406. The digital record can include at least one of a location, a pressure, a torque, an operator, or any other desirable parameter of the operation. In some illustrative examples, software controller on the tool 408 provides tool activation lockout based on condition of assembly and operator authorization 412 based on the digital MBE. Tool activation lockout based on condition of assembly and operator authorization 412 is optionally performed prior to performing the operation on the part using the tool.

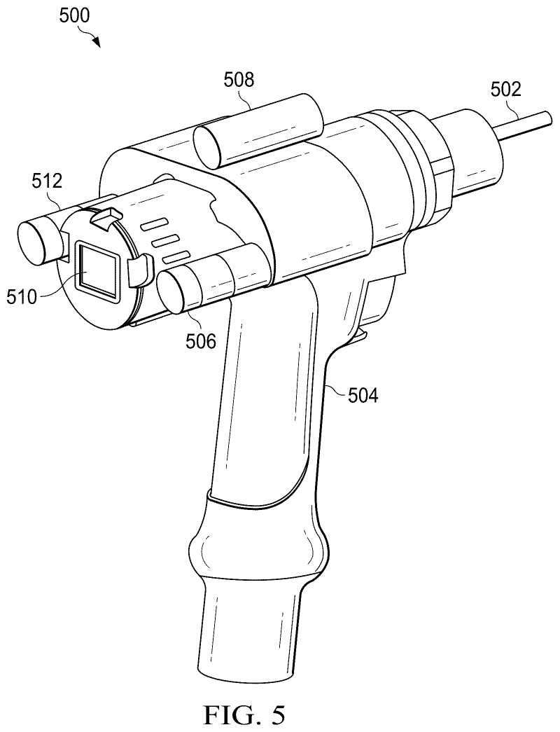

Turning now to FIG. 5, an illustration of an isometric view of a tool is depicted in accordance with an illustrative embodiment. Tool 500 can be used to assemble components of aircraft 100 of FIG. 1. Tool 500 can be a physical implementation of tool 202 of FIG. 2. Tool 500 can be used to implement method 300 of FIG. 3. Tool 500 can provide operations of software controller on tool 408 of FIG. 4.

Tool 500 can be any desirable tool to be employed in performing a manufacturing operation. Tool 500 can be used to implement any desirable task, such as an assembly task, whereby completion of the task is to be verified. In some illustrative examples, tool 500 can be a drill, a torque tool, a pneumatic impact tool, a rivet gun, or any other desirable tool to perform a designated operation.

Tool 500 comprises operative component 502 and tool body 504. Operative component 502 takes any desirable form. In one illustrative example, tool 500 is a drill and operative component 502 is a drill bit. In another illustrative example, tool 500 is a torque tool and operative component 502 is referred to as a wrench socket or a wrench head.

In this illustrative example, tool 500 comprises input sensor 506. Input sensor 506 can take any desirable form. In some illustrative examples, input sensor 506 can be used to receive input from an operator.

In this illustrative example, tool 500 comprises camera 508. Camera 508 can be used to take images or videos at least one of before, during, or after performing the operation. In some illustrative examples, at least one of a photo or a video is saved in a digital record after performing an operation with tool 500.

In this illustrative example, tool 500 comprises screen 510. Screen 510 can be used to display information regarding performance of an operation using tool 500. In some illustrative examples, screen 510 displays portions of work instructions for the operation. In some illustrative examples, screen 510 displays an alert prior to or following performing an operation using tool 500. In some illustrative examples, screen 510 displays performed parameters 208 during an operation.

In this illustrative example, tool 500 comprises location sensor 512. In some illustrative examples, tool 500 comprises location sensor 512 configured to determine a location of tool 500 within a work environment without an object location system.

The operation performed by tool 500 can be any assembly operation for any desirable part. In some illustrative examples, the operation can be at least one of drilling a hole, tightening a bolt, tightening a screw, securing a rivet, or any other desirable assembly operation. The operation can be determined from a model based engineering definition.

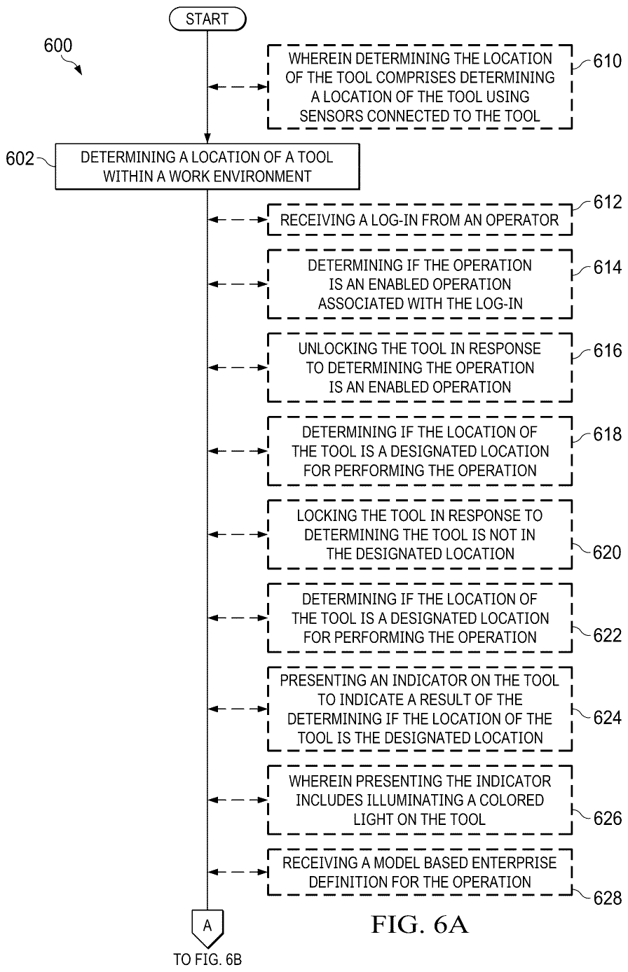

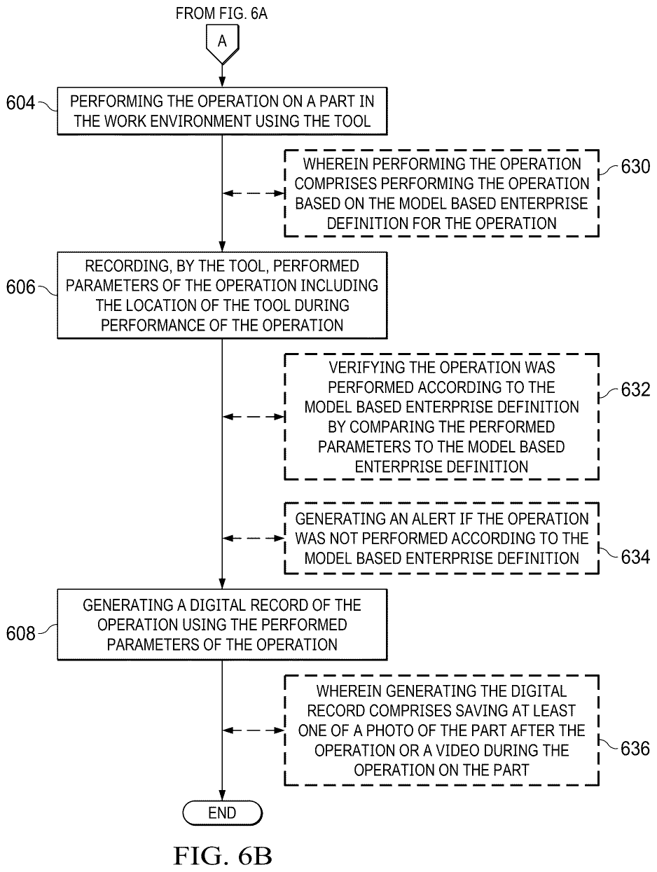

Turning now to FIGS. 6A and 6B, a flowchart of a method of performing and recording completion of an operation is depicted in accordance with an illustrative embodiment. Method 600 can be used to perform an operation in manufacturing a portion of aircraft 100 of FIG. 1. Method 600 can be performed using tool 202 of FIG. 2. Method 600 can be performed using tool 500 of FIG. 5.

Method 600 determines a location of a tool within a work environment (operation 602). Method 600 performs the operation on a part in the work environment using the tool (operation 604). Method 600 records, by the tool, performed parameters of the operation including the location of the tool during performance of the operation (operation 606). Method 600 generates a digital record of the operation using the performed parameters of the operation (operation 608). Afterwards, method 600 terminates.

In some illustrative examples, determining the location of the tool comprises determining a location of the tool using sensors connected to the tool (operation 610).

In some illustrative examples, method 600 receives a log-in from an operator (operation 612). The log-in can comprise any desirable data indicating an identity of an operator. The log-in can comprise at least one of a fingerprint, an iris, a facial scan, a PIN, a password, a RFID device, a QR code, a bar code, another desirable form of biometric log-in, or any other desirable form of log-in. In some illustrative examples, the tool logs the log-in to save the operator's identity as a performed parameter. In some illustrative examples, method 600 determines if the operation is an enabled operation associated with the log-in (operation 614). In some illustrative examples, method 600 unlocks the tool in response to determining the operation is an enabled operation (operation 616). In other illustrative examples, method 600 locks the tool if the operation is not an enabled operation for the operator. In some illustrative examples, the operation can use specialized training or expertise. Verifying whether an operator is allowed to perform the operation can prevent operations from being performed by untrained individuals.

In some illustrative examples, method 600 determines if the location of the tool is a designated location for performing the operation (operation 618). In some illustrative examples, method 600 locks the tool in response to determining the tool is not in the designated location (operation 620). In some illustrative examples, the designated location is relative to a part to receive the operation. In some illustrative examples, the designated location is relative to a specific hole, a specific bolt, a specific seam, or any other desirable feature of a structure.

In some illustrative examples, method 600 determines if the location of the tool is a designated location for performing the operation (operation 622). In some illustrative examples, method 600 presents an indicator on the tool to indicate a result of the determining if the location of the tool is the designated location (operation 624).

In some illustrative examples, presenting the indicator includes illuminating a colored light on the tool (operation 626).

In some illustrative examples, method 600 receives a model based engineering definition for the operation (operation 628). In some illustrative examples, performing the operation comprises performing the operation based on the model based engineering definition for the operation (operation 630).

In some illustrative examples, method 600 verifies the operation was performed according to the model based engineering definition by comparing the performed parameters to the model based engineering definition (operation 632).

In some illustrative examples, method 600 generates an alert if the operation was not performed according to the model based engineering definition (operation 634).

In some illustrative examples, generating the digital record comprises saving at least one of a photo of the part after the operation or a video during the operation on the part (operation 636).

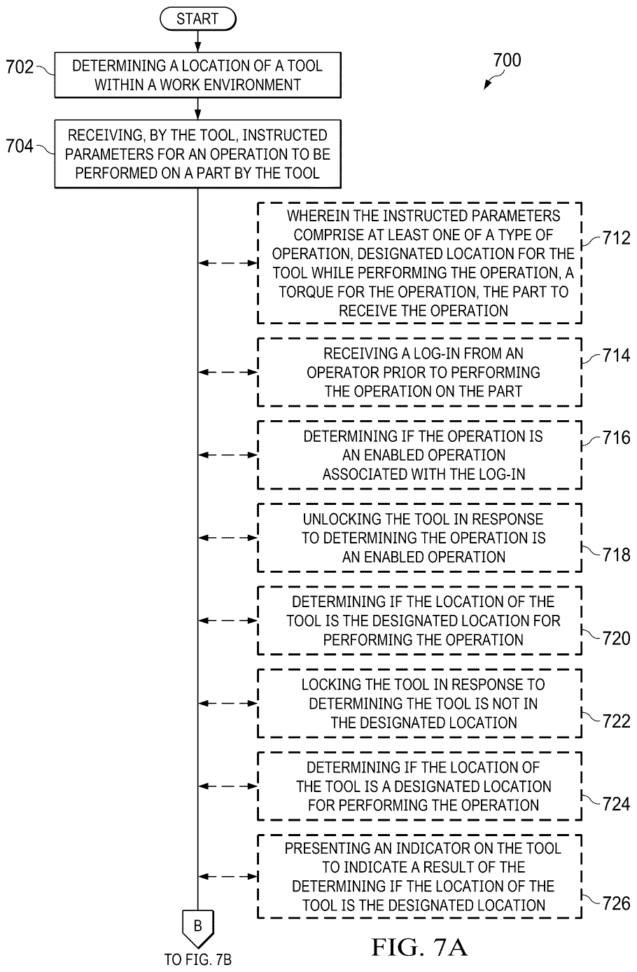

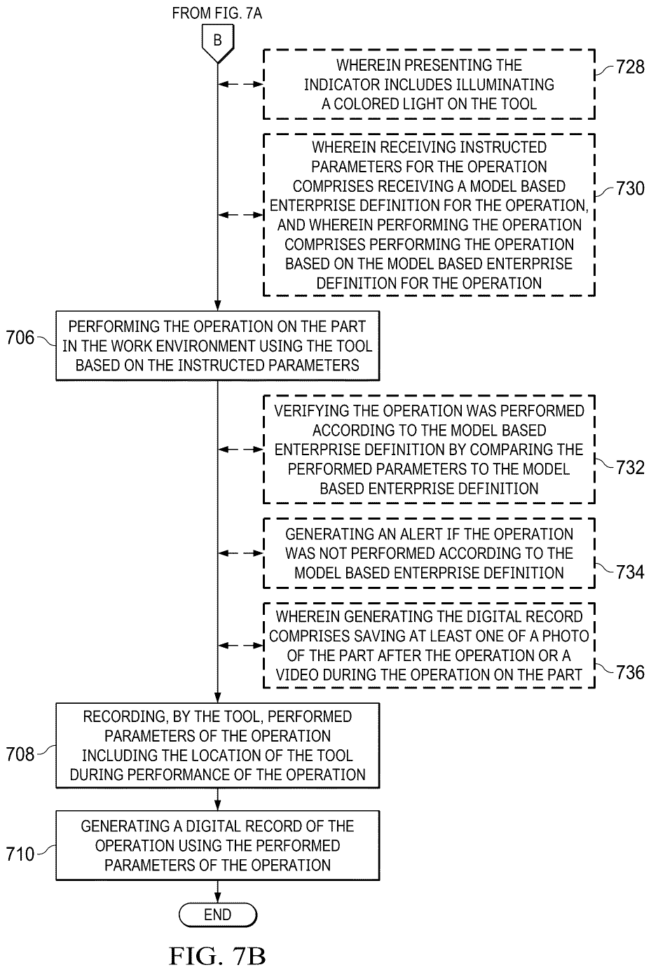

Turning now to FIGS. 7A and 7B, a flowchart of a method of performing and recording completion of an operation is depicted in accordance with an illustrative embodiment. Method 700 can be used to perform an operation in manufacturing a portion of aircraft 100 of FIG. 1. Method 700 can be performed using tool 202 of FIG. 2. Method 700 can be performed using tool 500 of FIG. 5.

Method 700 determines a location of a tool within a work environment (operation 702). Method 700 receives, by the tool, instructed parameters for an operation to be performed on a part by the tool (operation 704). Method 700 performs the operation on the part in the work environment using the tool based on the instructed parameters (operation 706). Method 700 records, by the tool, performed parameters of the operation including the location of the tool during performance of the operation (operation 708). Method 700 generates a digital record of the operation using the performed parameters of the operation (operation 710). Afterwards, method 700 terminates.

In some illustrative examples, the instructed parameters comprise at least one of a type of operation, designated location for the tool while performing the operation, a torque for the operation, the part to receive the operation (operation 712).

In some illustrative examples, method 700 receives a log-in from an operator prior to performing the operation on the part (operation 714). In some illustrative examples, method 700 determines if the operation is an enabled operation associated with the log-in (operation 716). In some illustrative examples, method 700 unlocks the tool in response to determining the operation is an enabled operation (operation 718).

In some illustrative examples, method 700 determines if the location of the tool is the designated location for performing the operation (operation 720). In some illustrative examples, method 700 locks the tool in response to determining the tool is not in the designated location (operation 722).

In some illustrative examples, method 700 determines if the location of the tool is a designated location for performing the operation (operation 724).

In some illustrative examples, method 700 presents an indicator on the tool to indicate a result of the determining if the location of the tool is the designated location (operation 726).

In some illustrative examples, presenting the indicator includes illuminating a colored light on the tool (operation 728).

In some illustrative examples, receiving instructed parameters for the operation comprises receiving a model based engineering definition for the operation, and wherein performing the operation comprises performing the operation based on the model based engineering definition for the operation (operation 730).

In some illustrative examples, method 700 verifies the operation was performed according to the model based engineering definition by comparing the performed parameters to the model based engineering definition (operation 732).

In some illustrative examples, method 700 generates an alert if the operation was not performed according to the model based engineering definition (operation 734).

In some illustrative examples, generating the digital record comprises saving at least one of a photo of the part after the operation or a video during the operation on the part (operation 736).

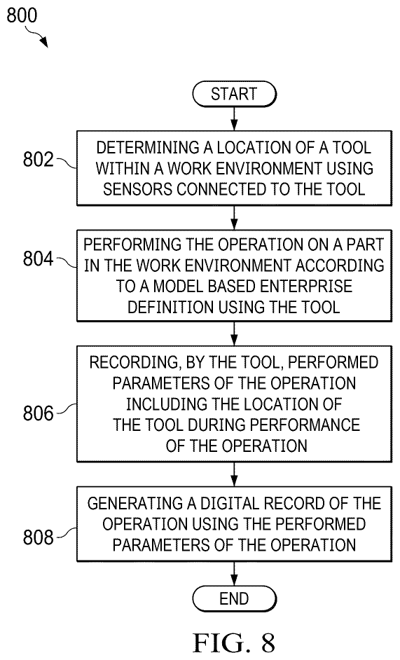

Turning now to FIG. 8, a flowchart of a method of performing and recording completion of an operation is depicted in accordance with an illustrative embodiment. Method 800 can be used to perform an operation in manufacturing a portion of aircraft 100 of FIG. 1. Method 800 can be performed using tool 202 of FIG. 2. Method 800 can be performed using tool 500 of FIG. 5.

Method 800 determines a location of a tool within a work environment using sensors connected to the tool (operation 802). Method 800 performs the operation on a part in the work environment according to a model based engineering definition using the tool (operation 804). Method 800 records, by the tool, performed parameters of the operation including the location of the tool during performance of the operation (operation 806). Method 800 generates a digital record of the operation using the performed parameters of the operation (operation 808). Afterwards, method 800 terminates.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 610 through operation 636 may be optional. As another example, operation 712 through operation 736 may be optional.

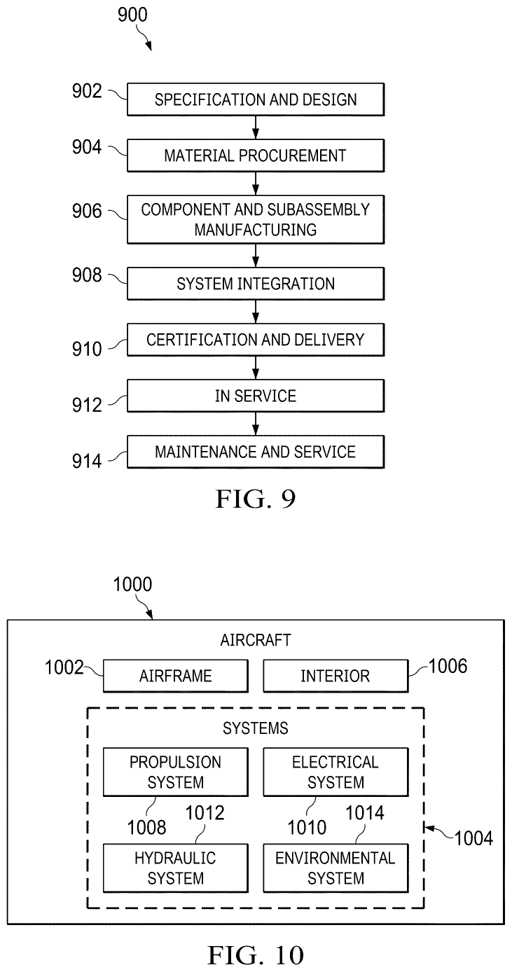

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in a form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

The illustrative examples track the position of a hand tool with respect to a three-dimensional model of the part while an operator completes a manual operation. The illustrative examples enable data generated during an operation to be automatically assigned to as built records of the part undergoing the operation. The illustrative examples provide automated condition of assembly checking and verification of work instructions in real time. The illustrative examples provide verification of who performed the process and how the process was completed. The illustrative examples provide automatic programming of tool settings.

The illustrative examples utilize a quality digital MBE definition of the work instructions, the part, and the work cell. The illustrative examples provide a system that automates work progress of manual tools. The system of the illustrative examples comprises a set of work instructions and identification of tools necessary to complete work instructions, the tools, and a plurality of sensors for localizing the tools. The illustrative examples record work progress in real time and provide real time alerts of work progress.

The illustrative examples improve manufacturing by performing and recording completion of operation. The illustrative examples reduce or eliminate sources of inconsistencies in performance of operation.

In the illustrative examples, work instructions can automatically show the current state of build and the next possible step(s) and tools to use. In some illustrative examples, an operator picks up the tool and verifies their identity for the digital record as well as authority to perform the operation. In these illustrative examples, the illustrative examples can verify that the operator is authorized to perform the operation. In some illustrative examples, it is determined if the operator is trained to do the work for the operation. The tool is aware of its physical location with respect to the operation. The tool may indicate using lights or projection the work operation location(s).

The operator moves the tool to one of the possible physical locations in which the work can be done. In some illustrative examples, the tool changes light state of colored light from red to green to show the current position represents a valid work operation based on the current condition of assembly. The tool locks out activation if not in a valid operation position.

The operator activates the tool. The tool records performed parameters including quality metrics where possible (rpm, feed, a photo, etc.). In some illustrative examples, the tool automatically informs a work order system when operation is completed. The tool automatically logs performed parameters including quality metrics with digital record of the work that was done.

The illustrative examples can assist the operator by reducing cognitive load. The illustrative examples reduce correlating work instruction intent with physical tasks. The illustrative examples provide quality improvements, improved record keeping, and improved compliance.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of performing and recording completion of an operation comprising:
determining a location of a tool within a work environment;
performing the operation on a part in the work environment using the tool;
recording, by the tool, performed parameters of the operation including the location of the tool during performance of the operation; and
generating a digital record of the operation using the performed parameters of the operation.

2. The method of claim 1 further comprising:
receiving a log-in from an operator;
determining if the operation is an enabled operation associated with the log-in; and
unlocking the tool in response to determining the operation is an enabled operation.

3. The method of claim 1 further comprising:
determining if the location of the tool is a designated location for performing the operation; and
locking the tool in response to determining the tool is not in the designated location.

4. The method of claim 1 further comprising:
determining if the location of the tool is a designated location for performing the operation; and
presenting an indicator on the tool to indicate a result of the determining if the location of the tool is the designated location.

5. The method of claim 4, wherein presenting the indicator includes illuminating a colored light on the tool.

6. The method of claim 1 further comprising:
receiving a model based engineering definition for the operation; and
wherein performing the operation comprises performing the operation based on the model based engineering definition for the operation.

7. The method of claim 6 further comprising:
verifying the operation was performed according to the model based engineering definition by comparing the performed parameters to the model based engineering definition.

8. The method of claim 7 further comprising:
generating an alert if the operation was not performed according to the model based engineering definition.

9. The method of claim 1, wherein determining the location of the tool comprises determining a location of the tool using sensors connected to the tool.

10. The method of claim 1, wherein generating the digital record comprises saving at least one of a photo of the part after the operation or a video during the operation on the part.

11. A method of performing and recording completion of an operation comprising:
determining a location of a tool within a work environment;
receiving, by the tool, instructed parameters for an operation to be performed on a part by the tool;
performing the operation on the part in the work environment using the tool based on the instructed parameters;
recording, by the tool, performed parameters of the operation including the location of the tool during performance of the operation; and
generating a digital record of the operation using the performed parameters of the operation.

12. The method of claim 11, wherein the instructed parameters comprise at least one of a type of operation, designated location for the tool while performing the operation, a torque for the operation, or the part to receive the operation.

13. The method of claim 11 further comprising:
receiving a log-in from an operator prior to performing the operation on the part;
determining if the operation is an enabled operation associated with the log-in; and
unlocking the tool in response to determining the operation is an enabled operation.

14. The method of claim 12 further comprising:
determining if the location of the tool is the designated location for performing the operation; and
locking the tool in response to determining the tool is not in the designated location.

15. The method of claim 11 further comprising:
determining if the location of the tool is a designated location for performing the operation; and
presenting an indicator on the tool to indicate a result of the determining if the location of the tool is the designated location.

16. The method of claim 15, wherein presenting the indicator includes illuminating a colored light on the tool.

17. The method of claim 11, wherein receiving instructed parameters for the operation comprises receiving a model based engineering definition for the operation, and wherein performing the operation comprises performing the operation based on the model based engineering definition for the operation.

18. The method of claim 17,
verifying the operation was performed according to the model based engineering definition by comparing the performed parameters to the model based engineering definition.

19. The method of claim 18 further comprising:
generating an alert if the operation was not performed according to the model based engineering definition.

20. The method of claim 11, wherein generating the digital record comprises saving at least one of a photo of the part after the operation or a video during the operation on the part.

21. A method of performing and recording completion of an operation comprising:
determining a location of a tool within a work environment using sensors connected to the tool;
performing the operation on a part in the work environment according to a model based engineering definition using the tool;
recording, by the tool, performed parameters of the operation including the location of the tool during performance of the operation; and
generating a digital record of the operation using the performed parameters of the operation.
